(19) United States
(12) Patent Application Publication
(10) Pub. No.: US 2009/0063978 A1
(43) Pub. Date: Mar. 5, 2009

(54) NETWORK STATUS ICON IN NAVIGABLE TOOLBAR

(75) Inventors: Thomas Patrick Dawson, San Diego, CA (US); Seth Hill, La Mesa, CA (US); Yuko Nishikawa, La Jolla, CA (US); Rolf Toft, Palo Alto, CA (US); George Williams, Carlsbad, CA (US)

Correspondence Address: ROGITZ & ASSOCIATES, 750 B STREET, SUITE 3120, SAN DIEGO, CA, 92101, US

(73) Assignees: Sony Corporation; Sony Electronics Inc.

(21) Appl. No.: 11/850,326

(22) Filed: Sep. 5, 2007

(51) Int. Cl. G06F 3/00

(52) U.S. Cl. 715/719

(57) ABSTRACT

A navigable graphic user interface (GUI) is presented on a TV screen and can be navigated by a user manipulating a remote control to select audio-video content for display on the TV. A network status icon is provided on the navigable GUI to indicate whether the Internet can be accessed from the TV to obtain audio-video content.

### FIELD OF THE INVENTION

The present invention relates generally to network status icons in navigable toolbars, particularly for Internet TVs.

### BACKGROUND OF THE INVENTION

TV manufacturers may wish to provide TVs with built-in interactive devices, e.g., personal video recorders (PVR), optical disk players such as Blu-Ray disk players and digital video disk (DVD) players and the like, so that a customer conveniently need purchase only the TV with interactive devices in a single seamless system. As recognized by the present assignee, it would be further desirable to provide the interactive devices with the TV in modular form so that as new and upgraded interactive devices become available, the TV system may be upgraded by replacing an old module with a new one without having to purchase an entirely new TV system.

The fusion of television with the Internet is a continuing goal that has spawned systems making it convenient for viewers to access content from both conventional TV sources and the Internet using a single TV chassis. In this way, the number of programs that can be made available to people using the familiar technology of television can be expanded enormously.

### SUMMARY OF THE INVENTION

Such a fusion, as understood herein, can be resolved using an Internet module in accordance with the discussion above. This is advantageous because while some products may possess the capability to be remotely updated via a software update, a television might not have such a capability. Furthermore, simply updating a product with software or with a new interface has shortcomings, such as not being able to accommodate industry standards for copy protection and not possessing innate mechanisms to restrict access to the interface, which is otherwise required to prevent unapproved devices from being attached to the interface. Accordingly, as recognized herein it is desirable to provide a means for a TV owner to add omitted functionality to the TV while providing the interface to do so with a mechanism for ensuring that only approved devices may be connected.

The present invention further understands that a complete solution may entail a graphic user interface (GUI) that integrates various choices a viewer may wish to make with respect to what is shown on the TV in an easy to use and intuitive fashion that builds on past GUI experiences a user may have had.

Accordingly, a method includes providing a navigable graphic user interface (GUI) on a TV screen. The GUI is navigable by a user manipulating a remote control to select audio-video content for display on the TV. A network status icon is provided on the navigable GUI to indicate whether a wide area computer network can be accessed from the TV to obtain audio-video content.

If desired, a text message can be displayed adjacent the icon that is related to network status. In non-limiting implementations the message indicates whether a connection with the network is being attempted and/or that updates are being checked for on the Internet and/or that authentication with a resource on the Internet is being undertaken and/or that services are being acquired from the Internet and/or that an acquired service is being retrieved from the Internet for display thereof on the TV.

Preferably, the icon dynamically updates according to network status without user interaction. Thus, the icon can bear a first appearance when no network communication exists and a second appearance when network communication exists. In some embodiments the first appearance is visible only if a network cable is plugged into the TV or an Internet module thereof, with the icon not appearing at all when the cable is unplugged.

In another aspect, a tangible digital storage medium is readable by a computer processor to display a user interface on a TV screen, and to permit a user to select items on the interface by manipulating a remote control. An Internet status icon is presented on the interface only when an Internet connection is sensed. The icon indicates whether audio-video content can be accessed from the Internet through the TV.

In yet another aspect, a TV is engageable with a hardware network module and can communicate with the module using high definition multimedia interface (HDMI) to provide content from the Internet to the TV. A processor causes a navigable menu to be displayed on the TV, and the menu includes an icon indicating whether the module is communicating with the Internet.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic view of a non-limiting system in accordance with present principles; and

FIG. 2 shows a GUI in accordance with present principles that may be displayed on screen, showing a network status icon.

### DETAILED DESCRIPTION OF THE PREFERRED EMBODIMENT

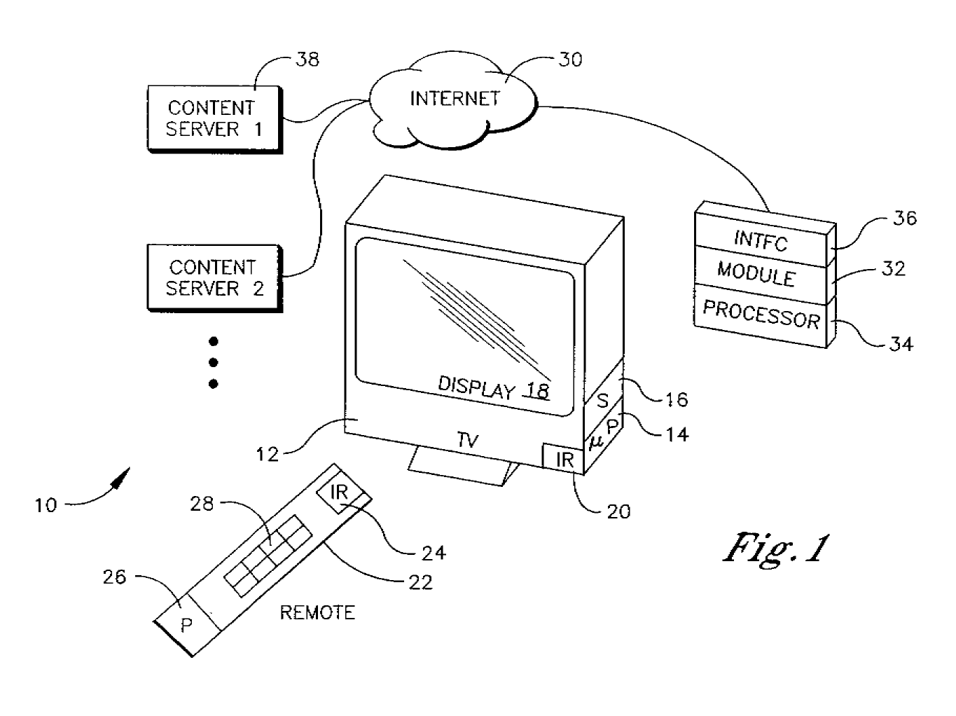

Referring initially to FIG. 1, a system is shown, generally designated 10, that includes a TV 12 with TV processor 14 and tangible digital storage medium 16 that may be, without limitation, a magnetic or optical disk drive, a solid state device such as random access memory or read-only memory or flash memory, a removable stick medium or removable floppy disk, etc. The medium 16 and processor 14 may be stored in the TV housing as shown along with a display 18 such as but not limited to a high definition (HD) matrix display or a standard definition cathode ray tube display, or the processor 14 and/or medium 16 may be external to the TV housing, e.g., in a set-top box or in the below-discussed module.

The TV 12 typically includes a wireless receiver such as but not limited to an IR receiver 20 for receiving wireless signals from a hand-held remote control 22 having a wireless transmitter such as but not limited to an IR transmitter 24. A processor 26 in the remote control 22 can receive input from a user-manipulable key array 28 in accordance with principles known in the art to cause the transmitter 24 to send wireless signals to the TV 12, including cursor control signals to move a cursor on the display 18.

In the non-limiting embodiment shown in FIG. 1, audio-video content from a wide area computer network such as the Internet 30 can be provided to the TV 12 for presentation on the display 18 using a hardware module 32 that may have a module processor 34. The module 32 may communicate with the TV 12 using a communication interface 36 such as a high definition multimedia interface (HDMI) to provide content from the Internet to the TV. The module 32 may be physically engaged with the housing of the TV 12 with communication being established by respective connectors on the module and TV, or the module 32 may be connected via a cord to the TV 12. In any case, the module 32 can be connected to the Internet typically by a computer cable that extends from the housing of the module 32 to an Internet jack, although the module 32 alternatively may communicate with the Internet wirelessly using, e.g., Wi-Fi.

As set forth further below, audio-video content may be provided from one or more content servers 38 on the Internet 30 via the module 32 for presentation on the TV display 18.

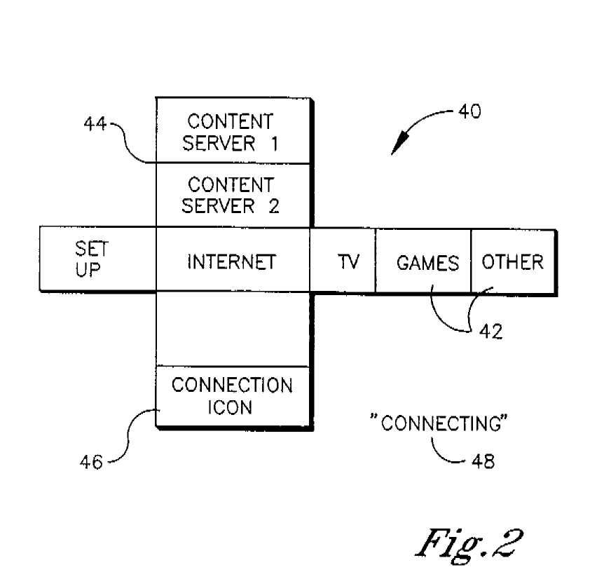

FIG. 2 shows a non-limiting implementation of a graphical user interface (GUI) 40 that can be generated in the module 32 and/or TV 12 and presented on the TV display 18. The implementation shown in FIG. 2 is colloquially referred to as a “cross media bar” or “XMB”. As shown, plural icons 42 are presented in an ordered horizontal list, with associated alpha-numeric application labels presented next to at least some of the icons 42 if desired. The icons 42 may be category icons, indicating, e.g., “set up”, “Internet” (or equivalently “my videos”), “TV”, “games”, etc. When the screen cursor is positioned over one of the icons 42, a vertical bar 44 is shown representing sub-menu choices for the particular icon 42 that is “in focus” by virtue of the screen cursor being positional over it. A user can select items on the GUI 40 by manipulating the remote control 22.

As shown in FIG. 2, when “Internet” is selected on the XMB a network status icon 46 can be shown on the vertical bar 44. Also, next to the network status icon 46, a text message 48 can be presented that relates to network status. In non-limiting implementations the text message 48 indicates whether a connection with the network is being attempted as shown, and may include an advisory that the task may consume some time. Messages 48 may also be displayed that updates are being checked for on the network, that authentication with the network is being undertaken, that services are being acquired from the network, and that an acquired service is being retrieved from the network.

In accordance with present principles, the status icon 46 is dynamically updated according to network status without user interaction. For example, when no network communication exists, the icon 46 can have a red color, whereas upon establishing communication with one of the servers 38 the icon 46 can assume a green color. Other appearance changes may be used. However, the status icon 46 may not be presented on the display 18 at all when, for instance, a network cable connecting the module 32 to an Internet jack is unplugged. Thus, in the non-limiting example described above the status icon 46 appears only when the module 32 is connected to the Internet and will assume a red color prior to establishing proper authenticated communication with a server 38, at which time the icon 46 can turn green.

While the particular NETWORK STATUS ICON IN NAVIGABLE TOOLBAR is herein shown and described in detail, it is to be understood that the subject matter which is encompassed by the present invention is limited only by the claims

What is claimed is:

1. A method, comprising:
providing a navigable graphic user interface (GUI) on a TV screen, the GUI being navigable by a user manipulating a remote control to select audio-video content for display on the TV; and
providing a network status icon on the navigable GUI indicating whether a wide area computer network can be accessed from the TV to obtain audio-video content.

2. The method of claim 1, comprising displaying a text message adjacent the icon and related to network status.

3. The method of claim 2, wherein the message indicates whether a connection with the network is being attempted.

4. The method of claim 2, wherein the message indicates that updates are being checked for on the network.

5. The method of claim 2, wherein the message indicates that authentication with the network is being undertaken.

6. The method of claim 2, wherein the message indicates that services are being acquired from the network.

7. The method of claim 2, wherein the message indicates that an acquired service is being retrieved from the network for display thereof on the TV.

8. The method of claim 1, wherein the icon dynamically updates according to network status without user interaction.

9. The method of claim 1, wherein the icon bears a first appearance when no network communication exists and a second appearance when network communication exists.

10. The method of claim 9, wherein the first appearance is visible only if a network cable is plugged into the TV or an Internet module thereof, the icon not appearing at all when the cable is unplugged.

11. A tangible digital storage medium readable by a computer processor to:
display a user interface on a TV screen;
permit a user to select items on the interface by manipulating a remote control; and
present an Internet status icon on the interface only when an Internet connection is sensed, the icon indicating whether audio-video content can be accessed from the Internet through the TV.

12. The tangible digital storage medium of claim 11, comprising displaying a text message adjacent the icon and related to network status.

13. The tangible digital storage medium of claim 12, wherein the message indicates whether a connection with the network is being attempted and/or that updates are being checked for on the Internet and/or that authentication with a resource on the Internet is being undertaken and/or that services are being acquired from the Internet and/or that an acquired service is being retrieved from the Internet for display thereof on the TV.

14. The tangible digital storage medium of claim 11, wherein the icon dynamically updates according to Internet communication status without user interaction.

15. The tangible digital storage medium of claim 11, wherein the icon bears a first appearance when no Internet communication exists and a second appearance when Internet communication exists.

16. The tangible digital storage medium of claim 15, wherein the first appearance is visible only if a network cable is plugged into the TV or an Internet module thereof, the icon not appearing at all when the cable is unplugged.

17. A system, comprising:
a TV;
a hardware network module engageable with the TV and communicating therewith using high definition multimedia interface (HDMI) to provide content from the Internet to the TV; and
at least one processor causing a navigable menu to be displayed on the TV, the menu including an icon indicating whether the module is communicating with the Internet.

18. The system of claim 17, wherein the processor causes a text message to be displayed adjacent the icon and related to network status.

19. The system of claim 18, wherein the processor dynamically updates the icon according to network status without user interaction.

20. The system of claim 19, wherein the icon bears a first appearance when no Internet communication exists and a second appearance when Internet communication exists, the first appearance being visible only if a network cable is plugged into the TV or the module, the icon not appearing at all when the cable is unplugged.
